(19) United States
(12) Patent Application Publication
(10) Pub. No.: US 2017/0075142 A1
(43) Pub. Date: Mar. 16, 2017

(54) Color Restrictive Eyeglasses

(71) Applicant: Raymond Thibault, Eagle River, AK (US)

(72) Inventor: Raymond Thibault, Eagle River, AK (US)

(21) Appl. No.: 14/852,148

(22) Filed: Sep. 11, 2015

(51) Int. Cl. G02C 7/10

(52) U.S. Cl. CPC G02C 7/104; G02C 7/108

(57) ABSTRACT

Embodiments are disclosed to provide for simulating the vision of animals. One embodiment is eyeglasses that simulate the vision of animals from a color perspective. The eyeglasses can be used by humans to view the perceptual differences in the color spectrum between what a human sees and what an animal sees. The eyeglasses operate by restricting particular color wavelengths that pass through the lenses. By simulating the color vision of animals, humans may better understand an animal's sight capabilities. The eyeglasses may allow humans to design improved training devices, adjust an animal's living environment according to their visual abilities, or adapt human behavior to conform to the animal's perceptual abilities.

### BACKGROUND OF THE INVENTION

Field of the Invention

The present invention refers to devices used for vision simulation, and more specifically, to devices used to simulate the vision of animals from a color perspective.

Description of the Related Art

The use of vision simulation devices has long been used in a plurality of fields. Eyeglasses which simulate alcoholic intoxication have been used in education systems in an attempt to teach youth about the dangers of drunk driving. Museums and exhibitions employ specialized glasses containing thousands of lenses which simulate the extraordinary view a common housefly may experience, adding insight as to why they are seemingly impossible to swat. Having the ability to view the world in specifically altered manners aids in the comprehension and understanding of how other organisms perceive their own surroundings. Unfortunately, no such device exists which simulates the color spectrum as seen and experienced by other animals.

Light, in all forms, is made up of electromagnetic radiation waves. Visible light, or color to humans, spans from the deep violet produced around the 380 nanometer wavelength to dark red, stemming from wavelengths around 740 nanometers in length. In the human eye, these waves of light are received by 6 to 7 million receptor cones located upon the retina. Within the cones, there are three distinct types with respect to the red, green, or blue color wavelengths perceived.

Within the vertebrates, humans have a unique distribution of cones which allows the perception of approximately 10 million different colors. Most other animals do not possess this distribution of cones, and as such, perceive color much differently than humans.

This differentiation can be problematic when attempting to understand the mannerisms or preferences of other species. It could be said there lies a need for a device which aids human/animal interaction by simulating the visual perceptions experienced by other species of animals. Such a device could be greatly beneficial within pluralities of animal training modalities. Additionally, pet owners may facilitate such a device to better understand errant behaviors of household animals by helping to identify favorable or outstanding features within the surroundings.

The present invention meets these needs by altering the wavelengths of perceivable light entering the device and providing the user with only those wavelengths visible by other animals.

Colors are what we perceive when we see varying wavelengths of light. The various visual spectrums perceived are due to the light-sensitive cells within the cones and rods of the eye. The amount of cones and rods and their wavelength discrimination ability are responsible for the various perceptions of the world of color among humans and animals.

Within the cone cells are color-responsive chemicals called pigments. There are three such pigments: red-sensitive, green-sensitive, and blue-sensitive. Each cone cell has one of these pigments so that it is sensitive to that color. The peak-absorbency wavelengths (in nanometers (nm) of the three cone types are: blue-445, green-535, red-570.

Most non-primate mammals are dichromatic, discriminating primarily between long and short wavelengths with two types of color-sensitive cones. Humans can see colors including red, orange, yellow, green, blue and violet. Note that in reality, there are not sharp differences between colors and they appear to blend together.

Old World primates are generally trichromatic, possessing color vision somewhat similar to humans. Birds, reptiles, fish, and insects are generally trichromatic and possess color vision based upon three cone types, but differing from human visual discrimination/perception.

Compared to humans, the canine would be considered color-vision deficient and perceives only a portion of the range of colors within the visual spectrum of light wavelengths. The canine visual system is capable of functioning under a wide range of lighting conditions, and is specially adapted to lower light conditions than humans. Part of this adaptation is facilitated by the fact that canines possess fewer color-sensitive cone photoreceptors than humans do. 20% or less of the central area retinal photoreceptors in the canine are cones and 80% rods, whereas humans possess 100% cone retinal photoreceptors within the fovea, the central area of the human retina.

The canine increased rod count allows dogs to have a greater ability to differentiate between subtle shades of gray and have improved vision in low-light conditions. The canine also possesses a tapetum lucidum, a highly reflective cell layer behind the photoreceptors in the retina. This tapetum lucidum allows improved low-light vision, and it is responsible for the shine of a dog's (and other species) eye when a bright light is directed at the dog in the dark. The tapetum lucidum also shifts the wavelength, via fluorescence, of light to match more closely the optimal wavelength sensitivity of the canine's rod photoreceptors, thus enhancing contrast. Pertaining to this project, the invention similarly shifts the wavelengths through filtering substrates and/or substrates to simulate the particular animal's vision, allowing that vision to be perceived by humans.

Color-matching tests and increment-threshold spectral sensitivity measurements in dogs indicate spectral peaks of 429 nm and 555 nm. Dogs possess two main cone photoreceptor types, maximally sensitive to blue-purple-violet wavelengths (429 to 440 nm) and yellow-green wavelengths (530 to 570 nm). These two main cone types form a general differentiation between two hues: one of violet to blue-violet in the range of 430-475 nm, predominantly perceived as blue, and one of greenish-yellow/yellow/red in the range of 400-620 nm, predominantly perceived as yellow. Dogs also perceive a spectrum in the blue-green range of 475-485 nm, which is predominantly perceived as shades of gray and white and is generally considered a spectral neutral point. Viewing the spectrum from its middle to the ends, color or wavelength changes are seen solely as changes in saturation, or vividness of hues or degree differences of gray and white. In mid-spectrum the wavelengths for the outputs of the two cone types are balanced (minimum saturation of both cone types), and it appears colorless.

The saturation, contrast and spectral sensitivity variances are responsible for perceptual differences, accounting for similar wavelengths to appear differently to humans and canines, as well as humans and other species; thus causing different colors to be perceived by human and animals within the same wavelengths. Humans perceive green at around 500 nm while a dog perceives the same wavelengths as a colorless void.

Dogs are dichromates and can somewhat be compared to red-green color-blind humans, otherwise known as deuteranopes. Light that appears blue-green to normal-sighted humans would appear as white and shades of gray to dogs. Colors that dogs are unable to clearly differentiate between appear to us as green to yellow-green, orange or red. Dogs can distinguish between red and blue, but often confuse green and red. Cats can detect more of the red-green zone if the stimuli are large enough and adequately differ in spectral content.

Cats possess three separate cone systems, similar to the human make-up. Peak sensitivities are 450, 500, and 555 nm. The 500 nm includes rods functioning above normal rod saturation levels. Cats have photopic (full color vision) trichromatic vision only at the end sensitivities and scotopic (involving only rods and no cones) trichromatic vision at the middle sensitivity. Blue and green sensitive cones act both separately and additively in color discrimination. Cats can discriminate between purple, blue, green, and gray. Cats can discriminate between red and cyan and between orange and cyan at a mesopic (involving both cones and rods) level, but they cannot perceive red color in and of themselves. Cats require much brighter colors to enable discrimination, generally requiring up to 10× brightness of background color. Brightness is a key factor.

### BRIEF SUMMARY OF THE INVENTION

The visual perception of the world of color is different for humans as compared to animals. It is commonly known that the more we are able to see the world through the eyes of another, the greater the understanding. This pertains not only to human societal perceptions of life in general, but also to the visual world of color regarding human and animal interrelationships. If we could visually experience and understand what our pets and other animals see in their world, we would have a greater understanding of their actions and how they relate to humans.

Thus, it is an object of this invention to produce a pair of eyeglasses that display the perceptual differences in the world of color between humans and the various animals that co-exist with us in the world. It is another object of the invention to provide an economical and simple means by which the ordinary layman may experience the perceptual differences in the world of color between humans and the various animals that co-exist with us in the world.

### BRIEF DESCRIPTION OF THE SEVERAL VIEWS OF THE DRAWING(S)

FIG. 1 is a representation of the visible color spectrum for humans as according to an embodiment of the present invention;

FIG. 2 is a representation of the visible color spectrum for canines as according to an embodiment of the present invention;

FIG. 3 is a representation of the visible color spectrum for humans wearing embodiments of the present invention;

FIG. 4 is a view of an eyeglass frame and lenses with a set of filters for simulating the color vision of canines as according to an embodiment of the present invention; and

FIG. 5 is a cross-section of a lens showing the filters in position as according to an embodiment of the present invention.

A further understanding of the present invention can be obtained by reference to preferred embodiments set forth in the illustrations of the accompanying drawings. Although the illustrated embodiments are merely exemplary for carrying out the present invention, both the organization and methods of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

Referring now to the present invention, there is described exemplary embodiments for viewing the same colors as animals. For the purpose of clarity, the terms “color restrictive eyeglasses”, “eyeglasses”, “present invention”, and “invention” may be used interchangeably to refer to the afore-mentioned apparatus for simulating the vision of animals invention.

Several preferred embodiments for simulating the vision of animals are discussed in this section. However, the invention is not limited to these embodiments. The present invention includes any form color restrictive eyeglasses for simulating the vision of animals using the chemical compounds as described below.

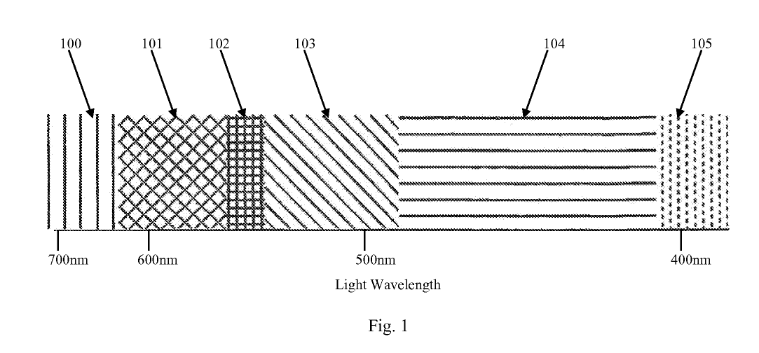

Referring now to FIGS. 1-3 that will be discussed together, there are shown representations of the color spectrum for humans and an exemplary animal, canines, and for humans wearing embodiments of the present invention. The Figures show wavelengths of light, as measured in nanometers, and the corresponding colors as seen by humans or canines FIG. 1 shows a range of light wavelengths from approximately 700 nm to approximately 400 nm and the corresponding colors as seen by a naked human eye. Humans can see the colors red (100), orange (101), yellow (102), green (103), blue (104), and violet (105). As perceived by the human eye, colors do not have sharp differences as light wavelengths lengthen or shorten, and instead there is color blending at the edge of each visible color zone.

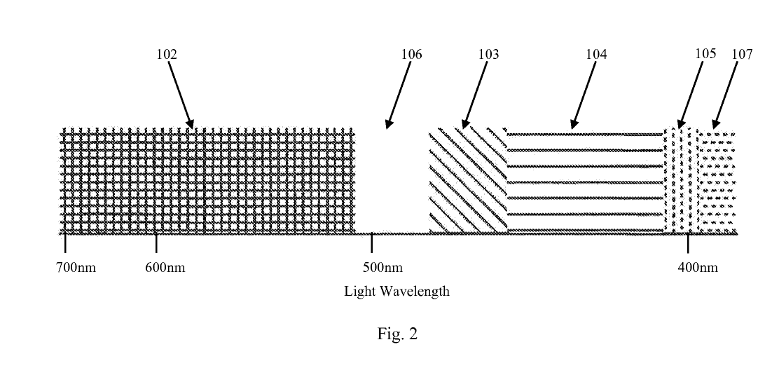

By contrast, canines have a much more limited range of visible color. FIG. 2 shows the colors that canines can see for corresponding wavelengths of light. Canines can see blue (102), but see white (106) for wavelengths of light that would correspond to some shades of green (103) for humans. Canines can see a gray versions of the colors green (103), blue (104), and violet (105). Canines also see gray (107) where humans would see shorter wavelengths of violet (105).

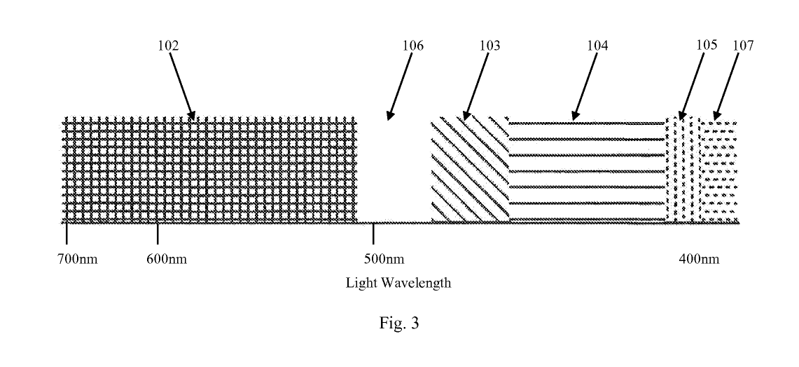

When humans wear embodiments of the present invention, they are able to view colors in a manner similar to animals and as illustrated here, canines. As seen in FIG. 3, humans wearing embodiments of the present invention can see can see blue (102), but see white (106) for wavelengths of light that would otherwise correspond to shades of green (103). Humans also see gray versions of the colors green (103), blue (104), and violet (105), and gray (107) for shorter wavelengths of violet. It is important to note that although an exemplary embodiment for simulating the vision of a canine is illustrated, the vision of other animals may be simulated by utilizing embodiments of the present invention.

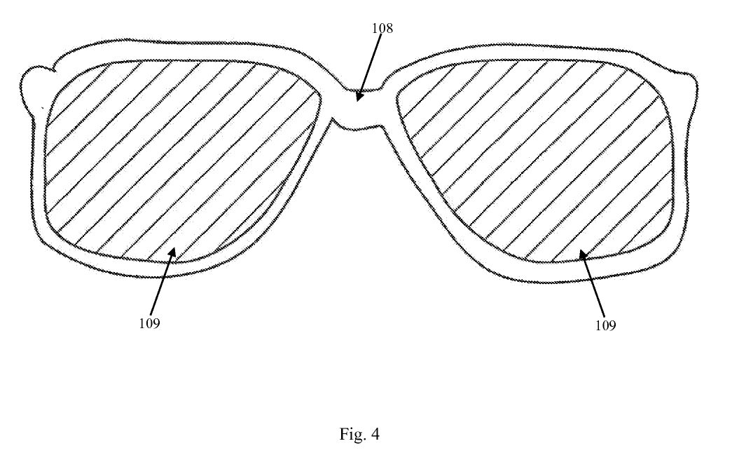

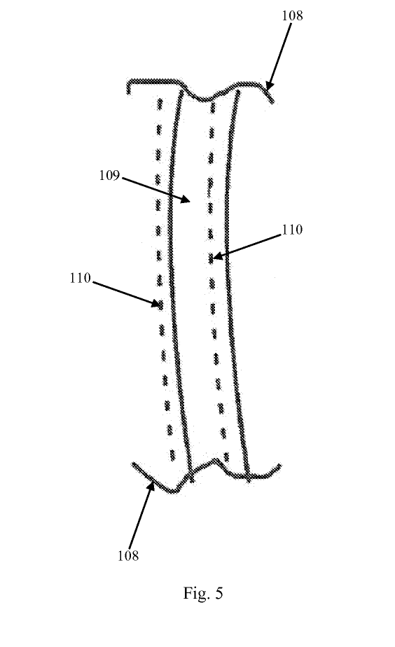

Referring now to FIGS. 4 and 5, there are shown views of color restricting eyeglasses as according to embodiments of the present invention. The eyeglasses generally comprise a frame (108) that holds one or more lenses (109) that have substrates or chemicals (110) applied to them. The substrates or chemicals (110) transform incoming light from that which would normally be visible to humans to colors as seen by canines by partially or completely blocking certain wavelengths of visible light while allowing other wavelengths of light to pass through the substrate (110). In addition, certain embodiments of the present invention provide substrates (110) that alter the wavelengths of visible light as the light passes through the substrate (110). That is, an exemplary wavelength of light enters the substrate at 680 nm, but is shortened to 510 nm by the time it exits the substrate (110).

The substrates or chemicals (110) can be placed on the surface of a lens (109), or can be included within a lens (109) as part of its composition. The substrates or chemicals (110) are generally acrylic or glass, depending on the compounds used to formulate the lenses (109).

The substrates or chemicals (110) comprise combinations of organic and inorganic chemicals in varying formulations and are applied to be reflective or non-reflective.

Some of the compounds used as the substrates or chemicals (110) include, but are not limited to, ferric oxide (Fe₂O₃), barium sulfate (BaSO₄), titanium oxide (TiO₂), variations of azurite (Cu₃(CO₃)₂(OH)₂) & (CoAl₂O₄), and ammonium manganese pyrophosphate variations (H₄MnNO₇P₂).

The aforementioned compounds used as the substrates or chemicals (110) alter the wavelengths of light by altering the color saturation, color contrast and color spectral sensitivity variances of the light for human viewing. The alterations allow humans to view a simulated interpretation of the world around them as the world is seen by varying animals.

Although certain exemplary embodiments for simulating the vision of animals have been described herein, the scope of coverage of this patent is not limited thereto. On the contrary, this patent covers all embodiments for simulating the vision of animals fairly falling within the scope of the invention either literally or under the doctrine of equivalents.

With respect to the above description then, it is to be realized that the optimum configuration and relationships for the elements for simulating the vision of animals are deemed readily apparent and obvious to one skilled in the art, and all equivalent relationships to those illustrated in the images and described in the specification are intended to be encompassed by the present invention.

Therefore, the foregoing is considered as illustrative only of the principles for simulating the vision of animals. Further, since numerous modifications and changes will readily occur to those skilled in the art, it is not desired to limit the center to the exact construction and operation shown and described, and accordingly, all suitable modifications and equivalents may be resorted to, falling within the scope for simulating the vision of animals. While the above description describes various embodiments of the present invention, it will be clear that the present invention may be otherwise easily adapted to satisfy any requirements for simulating the vision of animals.

As various changes could be made in the above configuration or organization without departing from the scope of the invention, it is intended that all matter contained in the above description or shown in the accompanying images shall be interpreted as illustrative and not in a limiting sense.

What is claimed is:

1. A pair of eyeglasses comprising:
an eyeglass frame; a pair of lenses; at least one substrate applied to each of the pair of lenses, whereby said substrate permits only the color saturation, color contrast and color spectral sensitivity variances visible to animals to be transmitted through the pair of lenses.

2. The pair of eyeglasses of claim 1 wherein the at least one substrate further restricts the color saturation, color contrast and color spectral sensitivity variances transmitted through the pair of lenses to be visible only to scotopic animals.

3. The pair of eyeglasses of claim 1 wherein the at least one substrate further restricts the color saturation, color contrast and color spectral sensitivity variances transmitted through the pair of lenses to be visible only to dichromate animals.

4. The pair of eyeglasses of claim 1 wherein the at least one substrate further restricts the color saturation, color contrast and color spectral sensitivity variances transmitted through the pair of lenses to be visible only to trichromatic animals.

5. The pair of eyeglasses of claim 1 wherein the at least one substrate comprises at least one of ferric oxide, barium sulfate, titanium oxide, azurite, or ammonium manganese pyrophosphate.

6. The pair of eyeglasses of claim 1 wherein each spectral sensitivity variance is one or more color wavelengths.

7. A pair of eyeglasses comprising:
an eyeglass frame; a pair of lenses; and a substrate material embedded in each of said pair of lenses whereby said substrate material permits only the color saturation, color contrast and color spectral sensitivity variances visible to animals to be transmitted through the pair of lenses.

8. The pair of eyeglasses of claim 7 wherein the substrate material further restricts the color saturation, color contrast and color spectral sensitivity variances transmitted through the pair of lenses to be visible only to scotopic animals.

9. The pair of eyeglasses of claim 7 wherein the substrate material further restricts the color saturation, color contrast and color spectral sensitivity variances transmitted through the pair of lenses to be visible only to dichromate animals.

10. The pair of eyeglasses of claim 7 wherein a substrate material comprises at least one of ferric oxide, barium sulfate, titanium oxide, azurite, or ammonium manganese pyrophosphate.

11. The pair of eyeglasses of claim 7 further comprising a plurality of substrates applied to each of said pair of lenses such that said plurality of substrates further restricts the color spectrum transmitted through the lenses.

12. A pair of eyeglasses comprising:
an eyeglass frame; a pair of lenses; at least one substrate, applied to each of the pair of lenses, whereby said at least one substrate shifts wavelengths of visible light transmitted through the pair of lenses to a wavelength that is visible to an animal after wavelength shifting by a tapetum lucidum cell layer.

13. The pair of eyeglasses of claim 12 wherein the wavelengths of light shifted by the substrate includes wavelengths between 429 nm to 440 nm and 530 nm to 570 nm.

14. The pair of eyeglasses of claim 12 wherein the wavelengths of light shifted by the at least one substrate are wavelengths visible to a scotopic animal.

15. The pair of eyeglasses of claim 12 wherein the wavelengths of light shifted by the at least one substrate are wavelengths visible to a dichromatic animal.

16. The pair of eyeglasses of claim 12 wherein the wavelengths of light shifted by the at least one substrate are wavelengths visible to a trichromatic animal.

17. The pair of eyeglasses of claim 12 wherein the at least one substrate enhances contrast to match a canine's sense of contrast.

18. The pair of eyeglasses of claim 12 wherein the at least one substrate comprises at least one of ferric oxide, barium sulfate, titanium oxide, azurite, or ammonium manganese pyrophosphate
